(19) United States
(12) Patent Application Publication
(10) Pub. No.: US 2020/0013349 A1
(43) Pub. Date: Jan. 9, 2020

(54) DISPLAY DEVICE AND DISPLAY BRIGHTNESS CONTROL METHOD THEREOF

(71) Applicant: E Ink Holdings Inc., HSINCHU (TW)

(72) Inventor: Pei-Sheng LEE, HSINCHU (TW)

(21) Appl. No.: 16/445,246

(22) Filed: Jun. 19, 2019

(30) Foreign Application Priority Data
Jul. 6, 2018 (TW) 107123557

(51) Int. Cl. G09G 3/34

(52) U.S. Cl. CPC G09G 3/3406; G09G 3/344; G06F 3/041; G09G 2320/0626; G09G 2354/00; G09G 2360/144

(57) ABSTRACT

A display device includes an electrophoretic display panel, a motion sensor, a use sensing module, an ambient light sensor, and a processor. The motion sensor is configured to sense a vector change of the electrophoretic display panel and a vector perpendicular to the electrophoretic display panel. The use sensing module is configured to sense a use signal of the electrophoretic display panel. The ambient light sensor is adjacent to the electrophoretic display panel and is configured to sense ambient light illumination. The processor is configured to increase brightness of the electrophoretic display panel when sensing the vector change or the using signal, and the vector is greater than or equal to zero, and the ambient light illumination is less than or equal to a set value. A method of controlling screen brightness of a display device is also provided.

### CROSS-REFERENCE TO RELATED APPLICATION

This application claims priority to Taiwan Application Serial Number 107123557, filed Jul. 6, 2018, which is herein incorporated by reference.

### BACKGROUND

### Field of Invention

The present disclosure relates to a display device and a method of controlling screen brightness of a display device.

### Description of Related Art

Ambient light sensors have been widely used in display devices to adjust screen brightness of the display devices. However, in practical applications, if only relying on the ambient light sensor to adjust the screen brightness of the display device, the screen brightness may be automatically adjusted when unnecessary, which gives a bad feeling of use.

### SUMMARY

A purpose of the present disclosure is to provide a display device, which includes an electrophoretic display panel, a motion sensor, a use sensing module, an ambient light sensor, and a processor. According to detection results of the motion sensor, the use sensing module and the ambient light sensor, it is determined whether to increase the brightness of the electrophoretic display panel to avoid automatically adjusting the screen brightness when unnecessary and thus giving a bad feeling of use.

The present disclosure provides a display device, which includes an electrophoretic display panel; a motion sensor configured to sense a vector change of the electrophoretic display panel and a vector perpendicular to the electrophoretic display panel; a use sensing module configured to sense a use signal of the electrophoretic display panel; an ambient light sensor adjacent to the electrophoretic display panel and configured to sense ambient light illumination; and a processor configured to increase brightness of the electrophoretic display panel when the vector change or the using signal is received, and the vector is greater than or equal to zero, and the ambient light illumination is less than or equal to a set value.

According to some embodiments of the present disclosure, the use sensing module includes a touch sensing unit, an operation sensing unit or a combination thereof.

According to some embodiments of the present disclosure, the operation sensing unit includes a keyboard, a mouse, an operation key or a combination thereof.

According to some embodiments of the present disclosure, the display device further includes a display panel disposed beneath or laterally adjacent to the electrophoretic display panel, and the display panel is another electrophoretic display panel or a liquid crystal display panel.

According to some embodiments of the present disclosure, the display device further includes a front light module disposed over the electrophoretic display panel, and the processor increases the brightness of the electrophoretic display panel through the front light module.

According to some embodiments of the present disclosure, the electrophoretic display panel, the motion sensor, the use sensing module and the ambient light sensor are electrically connected to the processor.

The present disclosure further provides a method of controlling screen brightness of a display device, which includes: sensing a vector change of an electrophoretic display panel using a motion sensor; sensing a use signal of the electrophoretic display panel using a use sensing module; sensing a vector perpendicular to the electrophoretic display panel using the motion sensor when the vector change or the using signal is received; sensing ambient light illumination using an ambient light sensor when the vector perpendicular to the electrophoretic display panel is greater than or equal to zero; and increasing brightness of the electrophoretic display panel when the ambient light illumination is less than or equal to a set value.

According to some embodiments of the present disclosure, the method further includes continually sensing the vector change and the use signal when the vector perpendicular to the electrophoretic display panel is less than zero.

According to some embodiments of the present disclosure, the method further includes continually sensing the vector change and the use signal when the ambient light illumination is greater than a set value.

According to some embodiments of the present disclosure, increasing the brightness of the electrophoretic display panel is conducted by a front light module.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a system block diagram of a display device according to some embodiments of the present disclosure;

FIG. 2 is a schematic view of a display device according to some embodiments of the present disclosure;

FIG. 3 is a cross-sectional view of an electrophoretic display panel and a front light module according to some embodiments of the present disclosure;

FIG. 4 is a schematic view of a display device according to some embodiments of the present disclosure;

FIG. 5 is a schematic view of a display device according to some embodiments of the present disclosure;

FIG. 6 is a flow chart of a method of controlling screen brightness of a display device according to some embodiments of the present disclosure;

FIGS. 7 and 8 are schematic views of display devices according to some embodiments of the present disclosure; and

FIGS. 9 and 10 are schematic views of display devices according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “over” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A purpose of the present disclosure is to provide a display device, which includes an electrophoretic display panel, a motion sensor, a use sensing module, an ambient light sensor, and a processor. According to detection results of the motion sensor, the use sensing module and the ambient light sensor, it is determined whether to increase the brightness of the electrophoretic display panel to avoid automatically adjusting the screen brightness when unnecessary and thus giving a bad feeling of use.

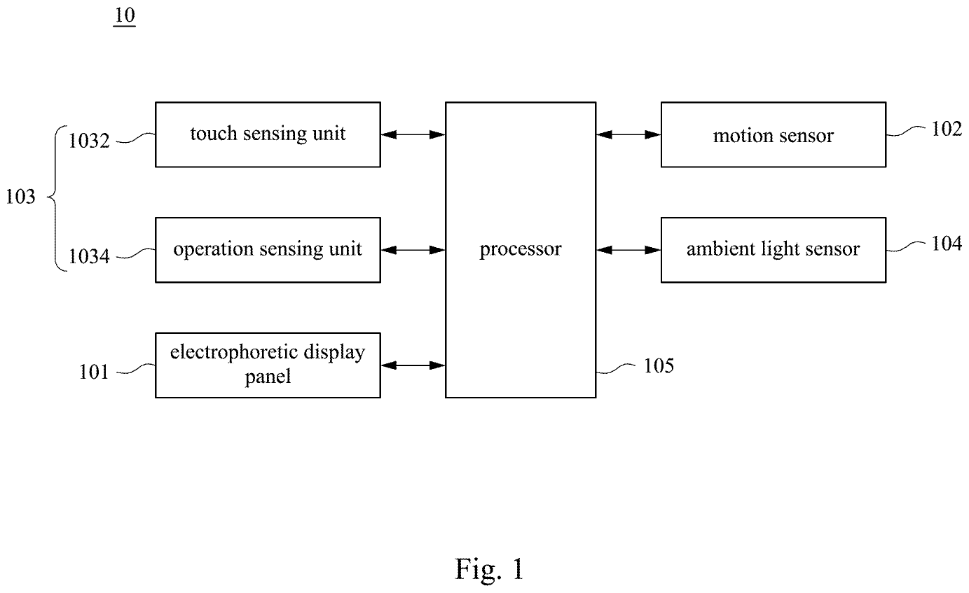

FIG. 1 is a system block diagram of a display device 10 according to some embodiments of the present disclosure. The display device 10 can be a portable electronic device, such as a mobile phone, a tablet, a notebook computer, or other mobile devices that support touch operations. As shown in FIG. 1, the display device 10 includes an electrophoretic display panel 101, a motion sensor 102, a use sensing module 103, an ambient light sensor 104, and a processor 105.

The motion sensor 102 is configured to sense a vector change of the electrophoretic display panel 101. Specifically, the motion sensor 102 can detect three-axis vectors of the electrophoretic display panel 101 and its change, and can also detect acceleration and momentum changes of the electrophoretic display panel 101 to initially determine whether the user is using the display device 10. In addition, the motion sensor 102 can also be used to sense a vector perpendicular to the electrophoretic display panel 101 to know the normal direction of a display surface of the electrophoretic display panel 101.

The use sensing module 103 is configured to sense a use signal of the electrophoretic display panel 101. In some embodiments, the use sensing module 103 includes a touch sensing unit 1032, an operation sensing unit 1034, or a combination thereof. In some embodiments, the operation sensing unit 1034 includes a keyboard, a mouse, an operational key (e.g., a power key or a home key), or a combination thereof. Whether the user is using the display device 10 is determined through the use sensing module 103.

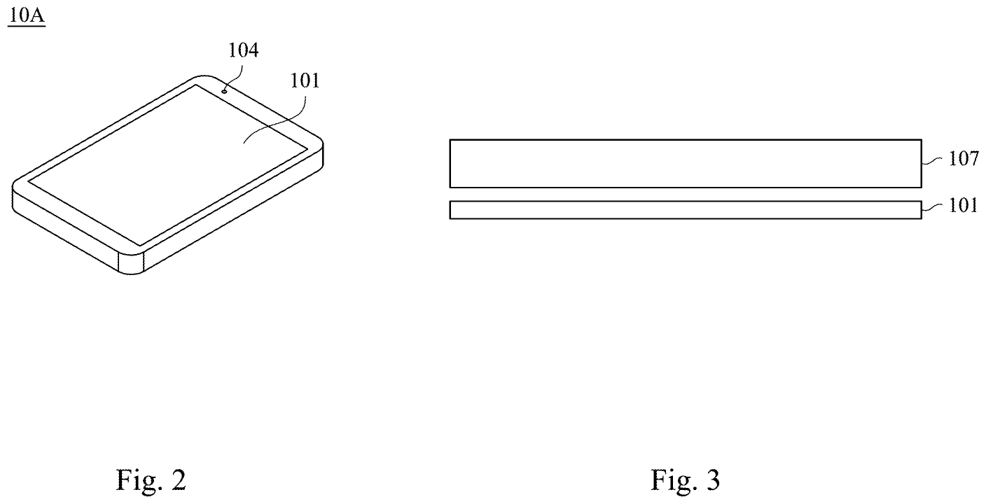

The ambient light sensor 104 is configured to sense ambient light illumination (i.e., light illumination of surrounding environment). FIG. 2 is a schematic view of a display device 10A according to some embodiments of the present disclosure. As shown in FIG. 2, the ambient light sensor 104 is adjacent to the electrophoretic display panel 101. In some embodiments, the motion sensor 102, the use sensing module 103, and the processor 105 shown in FIG. 1 may be disposed inside the display device 10A.

Referring to FIG. 1, the processor 105 is electrically connected to the electrophoretic display panel 101, the motion sensor 102, the use sensing module 103, and the ambient light sensor 104. The processor 105 can receive signals of the motion sensor 102, the use sensing module 103, and the ambient light sensor 104, and then determine whether to increase the brightness of the electrophoretic display panel 101 according thereto.

Specifically, the processor 105 can determine whether the user is using the display device according to the vector change or the use signal, and know the normal direction of the display surface of the electrophoretic display panel 101 according to the vector perpendicular to the electrophoretic display panel 101, and know the ambient light illumination according to the ambient light sensor 104, and thus to determine whether to increase the brightness of the electrophoretic display panel 101. When the processor 105 receives the vector change or the use signal, and the vector perpendicular to the electrophoretic display panel 101 is greater than or equal to zero, and the ambient light illumination is less than or equal to a set value, the brightness of the electrophoretic display panel 101 is raised.

FIG. 3 is a cross-sectional view of an electrophoretic display panel 101 and a front light module 107 according to some embodiments of the present disclosure. As shown in FIG. 3, the display device further includes a front light module 107 disposed over the electrophoretic display panel 101, and the processor 105 of FIG. 1 can enhance the brightness of the electrophoretic display panel 101 through the front light module 107.

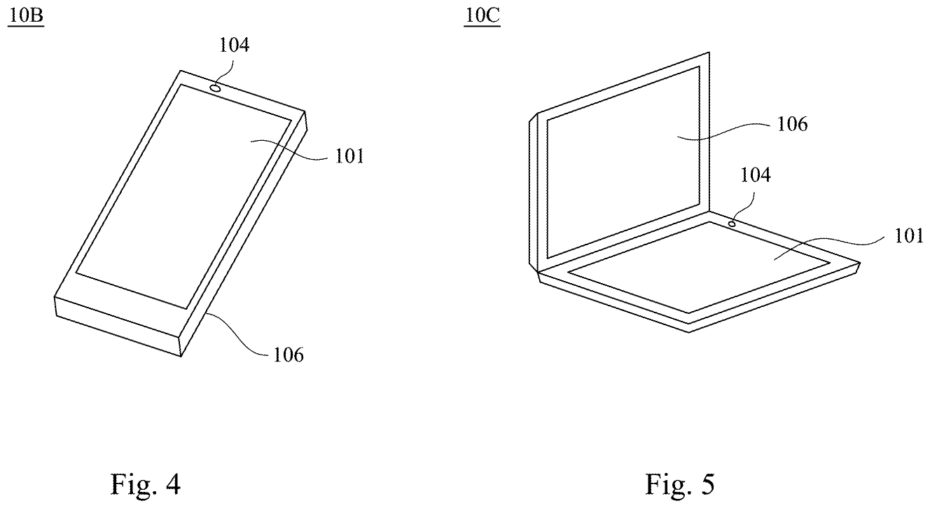

FIG. 4 is a schematic view of a display device 10B according to some embodiments of the present disclosure. FIG. 5 is a schematic view of a display device 10C according to some embodiments of the present disclosure. As shown in FIGS. 4 and 5, the display devices 10B and 10C further include another display panel 106, respectively. As shown in FIG. 4, the display panel 106 is located beneath the electrophoretic display panel 101. As shown in FIG. 5, the display panel 106 is laterally adjacent to the electrophoretic display panel 101. In some embodiments, the display panel 106 is another electrophoretic display panel or a liquid crystal display panel.

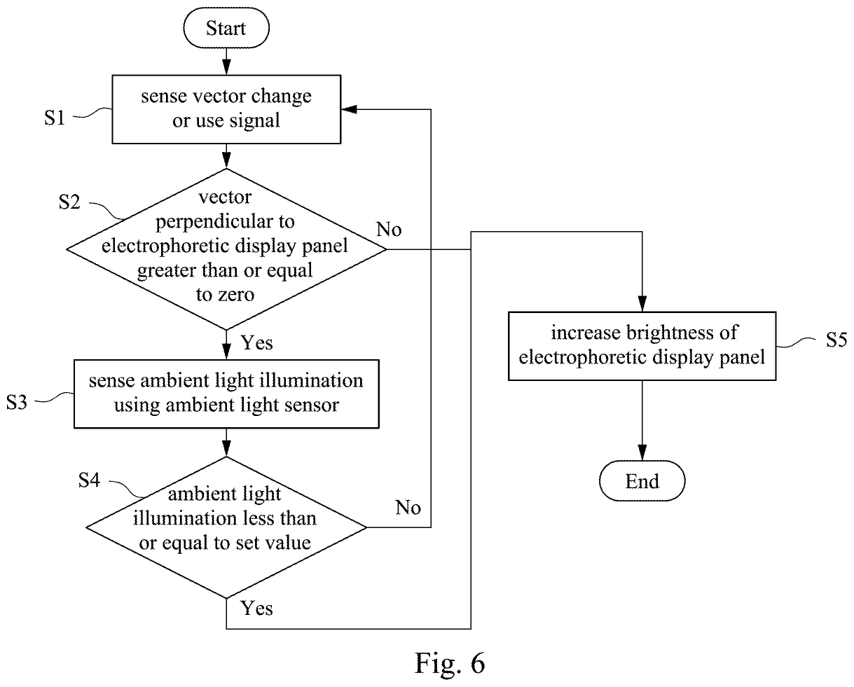

The present disclosure further provides a method of controlling screen brightness of a display device. FIG. 6 is a flow chart of a method of controlling screen brightness of a display device according to some embodiments of the present disclosure Referring to FIGS. 1 and 6, first, a vector change of the electrophoretic display panel 101 is sensed using the motion sensor 102, and a use signal of the electrophoretic display panel 101 is sensed using the use sensing module 103.

When the vector change or the use signal is received (i.e., step S1), a vector perpendicular to the electrophoretic display panel 101 is sensed using the motion sensor 102 to know the normal direction of the display surface of the electrophoretic display panel 101.

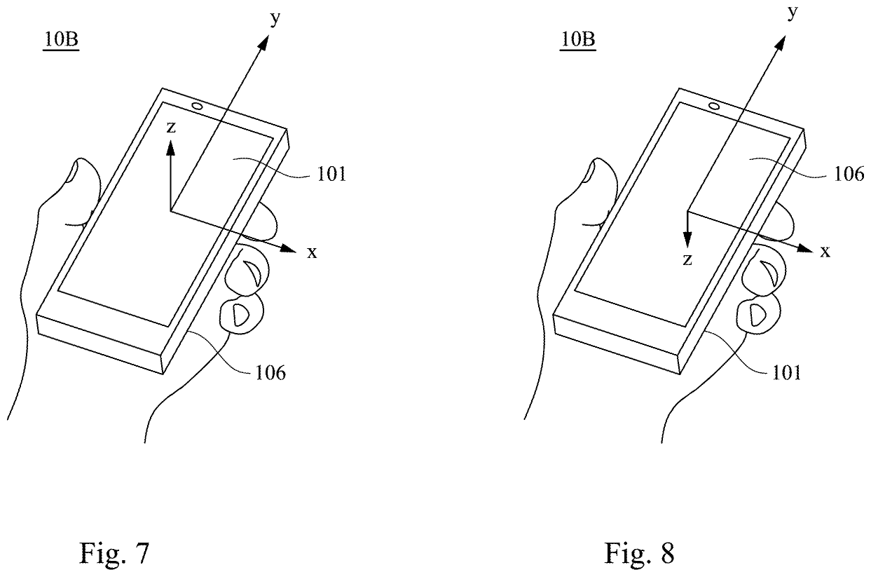

Several different states of the display device are listed below. FIGS. 7 and 8 are schematic views of display devices 10B according to some embodiments of the present disclosure. As shown in FIG. 7, it can be sensed that the vector perpendicular to the electrophoretic display panel 101 (i.e., vector z) is greater than zero, that is, the normal direction of the display surface of the electrophoretic display panel 101 is upward. As shown in FIG. 8, it can be sensed that the vector z is smaller than zero, that is, the normal direction of the display surface of the electrophoretic display panel 101 is downward.

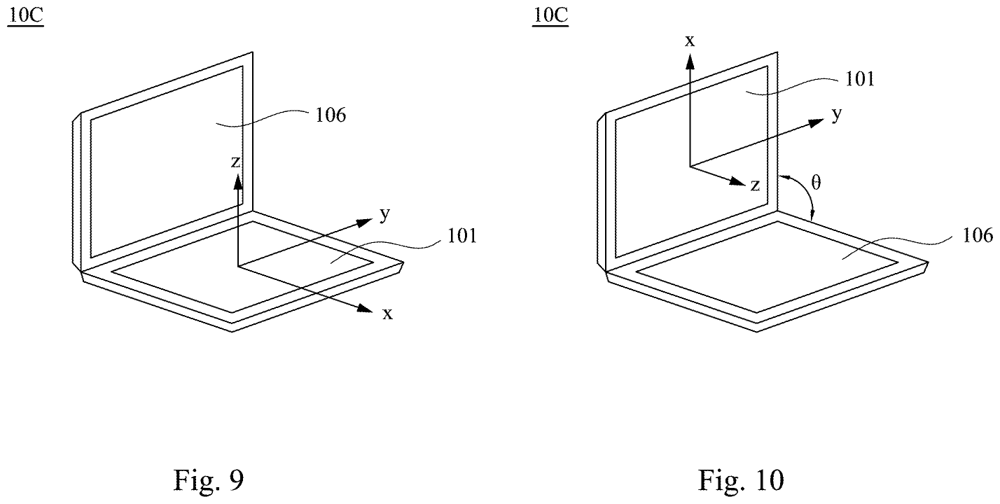

FIGS. 9 and 10 are schematic views of display devices 10C according to some embodiments of the present disclosure. As shown in FIG. 9, it can be sensed that the vector z is greater than zero. As shown in FIG. 10, when an angle θ between the electrophoretic display panel 101 and the display panel 106 is greater than 90 degrees, the vector z may be sensed to be greater than zero. In other embodiments, when the angle θ between the electrophoretic display panel 101 and the display panel 106 is equal to 90 degrees, the vector z is sensed to be equal to zero.

Referring to FIGS. 1 and 6, when the vector perpendicular to the electrophoretic display panel 101 is greater than or equal to zero (i.e., step S2), ambient light illumination is sensed using the ambient light sensor 104 (i.e., step S3). When the ambient light illumination is less than or equal to a set value (i.e., step S4), the brightness of the electrophoretic display panel 101 is increased (i.e., step S5). In some embodiments, the brightness of the electrophoretic display panel 101 is conducted by the front light module.

In some embodiments, as shown in FIG. 6, when the vector perpendicular to the electrophoretic display panel is less than zero, the vector change and the use signal are continually sensed. In some embodiments, as shown in FIG. 6, when the ambient light illumination is greater than the set value, the vector change and the use signal are continually sensed.

The method of controlling the screen brightness determines whether to raise the brightness of the electrophoretic display panel (i.e., step S5) according to a series of steps (i.e., steps S1 to S4), instead of relying solely on the detection result of the ambient light sensor. Therefore, it is possible to avoid automatically adjusting the screen brightness when unnecessary and thus giving a bad feeling of use.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A display device, comprising:
an electrophoretic display panel;
a motion sensor configured to sense a vector change of the electrophoretic display panel and a vector perpendicular to the electrophoretic display panel;
a use sensing module configured to sense a use signal of the electrophoretic display panel;
an ambient light sensor adjacent to the electrophoretic display panel and configured to sense ambient light illumination; and
a processor configured to increase brightness of the electrophoretic display panel when the vector change or the using signal is received, and the vector is greater than or equal to zero, and the ambient light illumination is less than or equal to a set value.

2. The display device of claim 1, wherein the use sensing module comprises a touch sensing unit, an operation sensing unit or a combination thereof.

3. The display device of claim 2, wherein the operation sensing unit comprises a keyboard, a mouse, an operation key or a combination thereof.

4. The display device of claim 1, further comprising:
a display panel disposed beneath or laterally adjacent to the electrophoretic display panel, and the display panel being another electrophoretic display panel or a liquid crystal display panel.

5. The display device of claim 1, further comprising:
a front light module disposed over the electrophoretic display panel, and the processor increasing the brightness of the electrophoretic display panel through the front light module.

6. The display device of claim 1, wherein the electrophoretic display panel, the motion sensor, the use sensing module and the ambient light sensor are electrically connected to the processor.

7. A method of controlling screen brightness of a display device, comprising:
sensing a vector change of an electrophoretic display panel using a motion sensor;
sensing a use signal of the electrophoretic display panel using a use sensing module;
sensing a vector perpendicular to the electrophoretic display panel using the motion sensor when the vector change or the using signal is received;
sensing ambient light illumination using an ambient light sensor when the vector perpendicular to the electrophoretic display panel is greater than or equal to zero; and
increasing brightness of the electrophoretic display panel when the ambient light illumination is less than or equal to a set value.

8. The method of claim 7, further comprising:
continually sensing the vector change and the use signal when the vector perpendicular to the electrophoretic display panel is less than zero.

9. The method of claim 7, further comprising:
continually sensing the vector change and the use signal when the ambient light illumination is greater than a set value.

10. The method of claim 7, wherein increasing the brightness of the electrophoretic display panel is conducted by a front light module.
